(19) United States
(12) Patent Application Publication
(10) Pub. No.: US 2023/0311003 A1
(43) Pub. Date: Oct. 5, 2023

(54) DECISION MODEL TRAINING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Qiyang CAO, Shenzhen (CN); Ruochen LIU, Shenzhen (CN); Sze Yeung LIU, Shenzhen (CN); Yuan ZHOU, Shenzhen (CN)

(73) Assignee: Tencent Technology (Shenzhen) Company Limited, Shenzhen (CN)

(21) Appl. No.: 18/330,794

(22) Filed: Jun. 7, 2023

Related U.S. Application Data
(63) Continuation of application No. PCT/CN2022/129093, filed on Nov. 1, 2022.

(30) Foreign Application Priority Data
Jan. 20, 2022 (CN) 202210067450.7

(51) Int. Cl. A63F 13/67; A63F 13/58

(52) U.S. Cl. CPC A63F 13/67; A63F 13/58

(57) ABSTRACT

A decision model training method and apparatus are provided. The method may include: obtaining model pools of virtual characters, the model pools including decision models corresponding to the virtual characters, and the decision models being used for indicating battle policies adopted by the virtual characters in battles; updating and training n^{th} decision models of the virtual characters based on battle data of a battle between the virtual characters in an n^{th} iteration process to obtain n+1^{th} decision models of the virtual characters; adding the n+1^{th} decision models to the model pools of the corresponding virtual characters; and determining, based on an iterative training end condition being satisfied, decision models obtained by the last round of training in the model pools as target decision models of the virtual characters.

### CROSS REFERENCE TO RELATED APPLICATION

This application is a continuation of International Application No. PCT/CN2022/129093, filed on Nov. 1, 2022 and claims priority to Chinese Patent Application No. 202210067450.7 filed on Jan. 20, 2022, the contents of which are incorporated by reference herein in their entirety.

### FIELD

Embodiments of the disclosure relate to the field of artificial intelligence (AI), and in particular, to a decision model training method and apparatus, a device, a storage medium, and a program product.

### BACKGROUND OF THE DISCLOSURE

At present, in fighting games, players may battle against a machine. That is, the players may battle against a game AI with a certain policy and decision-making ability.

In the related art, AI may be trained by reinforcement learning to battle. In a training process, an AI decision model is trained by using battle data of different characters, and an AI battle policy is optimized, thereby improving the AI battle winning rate. The AI decision model trained in this way may be applied to all characters and is a general decision model.

However, different characters in fighting games have different character characteristics, such as long-range attack, close combat, and defensive characters, and different characters need to adopt different policies in the battle. If the general decision model is adopted to control virtual characters to battle, the character characteristics may be limited, and the AI battle winning rate may be limited.

### SUMMARY

This embodiment of the disclosure provides a decision model training method and apparatus, a device, a storage medium, and a program product, which contribute to improving the battle winning rates of virtual characters in a battle based on decision models. The technical solutions are as follows.

According to an aspect, this embodiment of the disclosure provides a decision model training method. The method is performed by a computer device. The method may include obtaining model pools of virtual characters, the model pools including decision models corresponding to the virtual characters, and the decision models being used for indicating battle policies adopted by the virtual characters in battles. The method may further include updating and training n^{th} decision models of the virtual characters based on battle data of a battle between the virtual characters in an n^{th} iteration process to obtain n+1^{th} decision models of the virtual characters, and adding the n+1^{th} decision models to the model pools of the corresponding virtual characters. The method may further include determining, based on an iterative training end condition being satisfied, decision models obtained by the last round of training in the model pools as target decision models of the virtual characters. According to other aspects of one or more embodiments, there is also provided an apparatus and non-transitory computer readable medium consistent with the method.

### BRIEF DESCRIPTION OF THE DRAWINGS

To describe the technical solutions in the example embodiments of the disclosure more clearly, the following briefly introduces the accompanying drawings required for describing the example embodiments. The accompanying drawings in the following description show merely some embodiments of the disclosure, and a person of ordinary skill in the art may still derive other accompanying drawings from the accompanying drawings without creative efforts. In addition, one of ordinary skill would understand that aspects of example embodiments may be combined together or implemented alone.

FIG. 1 shows a schematic diagram of a decision model training method according to some embodiments.

FIG. 2 shows a schematic diagram of an implementation environment according to some embodiments.

FIG. 3 shows a flowchart of a decision model training method according to some embodiments.

FIG. 4 shows a schematic structural diagram of a decision model according to some embodiments.

FIG. 5 shows a flowchart of a decision model training method according to some embodiments.

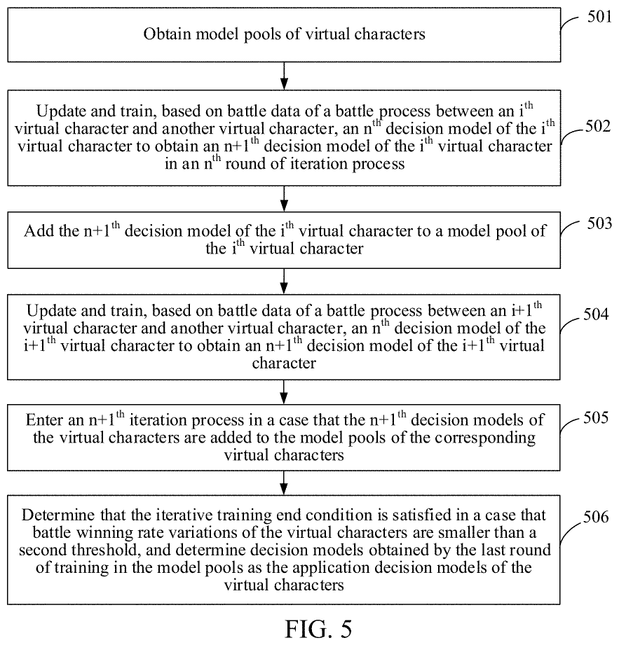

FIG. 6 shows a schematic diagram of updating and training in an n^{th} iteration process according to some embodiments.

FIG. 7 shows a flowchart of a decision model training method according to some embodiments.

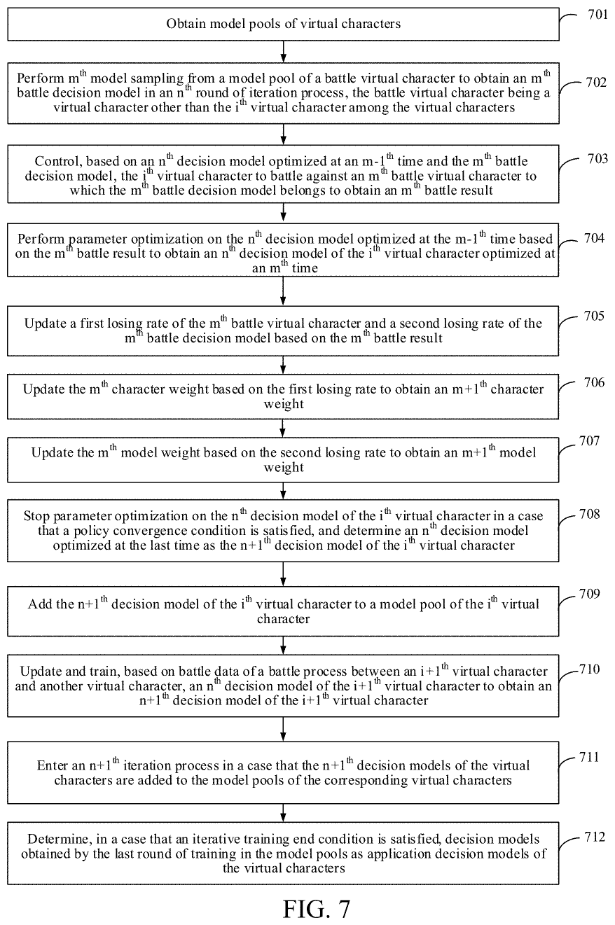

FIG. 8 shows a schematic diagram of a model weight updating process according to some embodiments.

FIG. 9 shows a schematic diagram of updating and training in an n^{th} iteration process according to some embodiments.

FIG. 10 shows a flowchart of a decision model training method according to some embodiments.

FIG. 11 shows a schematic variation diagram of battle winning rates of virtual characters after iterative training according to some embodiments.

FIG. 12 shows a structural block diagram of a decision model training apparatus according to some embodiments.

FIG. 13 shows a structural block diagram of a computer device according to some embodiments.

### DETAILED DESCRIPTION

To make the objectives, technical solutions, and advantages of the disclosure clearer, implementations of the disclosure are further described in detail below with reference to the accompanying drawings.

In fighting games, players battle against AI. In the related art, when training AI in games, a decision model is usually obtained by training multiple sets of battle data. The multiple sets of battle data contain battle data of a battle process between different virtual characters. That is, the model is trained by battle data between any virtual characters. In this way, a general decision model will be trained, which is suitable for any virtual character. Then, different virtual characters have different character characteristics. In a battle, different battle policies need to be adopted for battling. For example, long-range attack virtual characters and close combat virtual characters need to adopt different battle policies for battling. If the virtual characters are controlled to battle through the general decision model, the character characteristics of the virtual characters will be limited, and accordingly, the battle winning rate of the virtual characters will be limited.

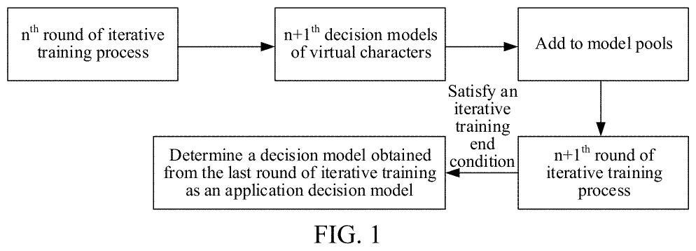

Therefore, in the embodiments of the disclosure, as shown in FIG. 1, in an n^{th} round of iterative training process, n^{th} decision models of virtual characters are updated and trained using battle data between the virtual characters to obtain n+1^{th} decision models of the virtual characters, thereby adding the n+1^{th} decision models into corresponding model pools, continuing an n+1^{th} round of iterative training process, and obtaining application decision models corresponding to the virtual characters when an iterative training end condition is satisfied. That is, through several rounds of iterative training process, specific decision models of the virtual characters are trained, thereby improving the battle winning rates of the virtual characters in the battle based on the decision models.

After the application decision models corresponding to the virtual characters are trained, the application decision models may be applied to a battle scene between any player and AI. This embodiment is not limited thereto.

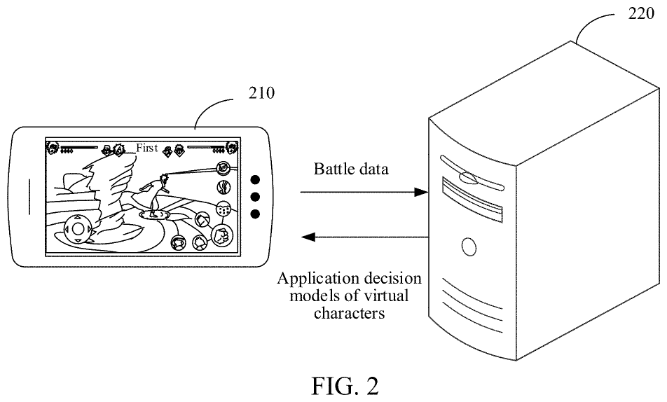

FIG. 2 shows a schematic diagram of an implementation environment according to an exemplary embodiment of the disclosure. The implementation environment includes a terminal 210 and a server 220. Data communication is performed between the terminal 210 and the server 220 via a communication network. The communication network may be a wired network or a wireless network, and the communication network may be at least one of a local area network, a metropolitan area network, and a wide area network.

The terminal 210 includes, but is not limited to, a mobile phone, a computer, an intelligent voice interaction device, an intelligent household appliance, a vehicle-mounted terminal, and the like. An application supporting a virtual environment is run in the terminal 210, and the application may be a multiplayer online battle program. When the application is run in the terminal 210, a user interface of the application is displayed on a screen of the terminal 210. The application may be any one of a multiplayer online battle arena (MOB A) game, a simulation game (SLG), and a fighting game. In this embodiment, the application is illustrated by being a fighting game.

The server 220 may be an independent physical server, a server cluster or a distributed system composed of multiple physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms. In this embodiment of the disclosure, the server 220 is a background server of the fighting game in the terminal 210, and may receive battle data of a battle between virtual characters in the terminal 210, so as to update and train decision models of the virtual characters based on the battle data to obtain application decision models of the virtual characters.

In some embodiments, the foregoing decision model training process may also be performed by the terminal 210. This embodiment of the disclosure is not limited thereto. For convenience of expression, the following embodiments are illustrated with an example in which a decision model training method is performed by a computer device.

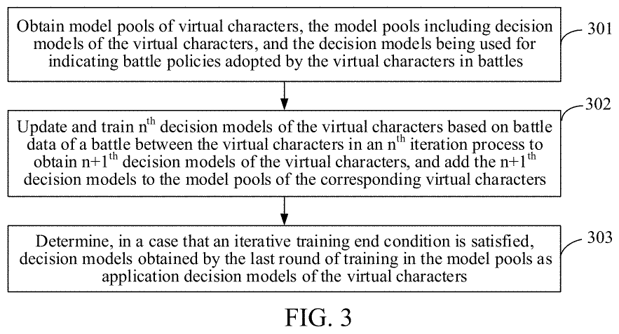

FIG. 3 shows a flowchart of a decision model training method according to an exemplary embodiment of the disclosure. This embodiment is illustrated with an example in which the method is applied to a computer device. The method may include the following operations:

Operation 301: Obtain model pools of virtual characters, the model pools including decision models of the virtual characters, and the decision models being used for indicating battle policies adopted by the virtual characters in battles.

Different virtual characters have different character characteristics. For example, virtual characters may be good at long-range attack, close combat or defense. In this embodiment of the disclosure, different model pools are maintained for different virtual characters. A specific decision model corresponding to each virtual character is stored in the model pool.

The decision model is used for indicating a battle policy adopted by the virtual character in a battle. When the virtual character is controlled to battle based on the decision model, the computer device may input a battle state between the virtual character and an opponent into the decision model to obtain a corresponding battle policy. The battle state may include position information, skill information, and carried element information of both characters of the battle, battle remaining duration, and the like. The battle policy may include an action policy, a skill policy, and the like. The action policy may be used for indicating a moving manner of the virtual character, for example, including a left-right displacement action, an up-down displacement action, and the like. The skill policy includes a skill casting time, a skill casting type, and the like.

In some embodiments, the model pool of the same virtual character stores different decision models corresponding to the virtual character.

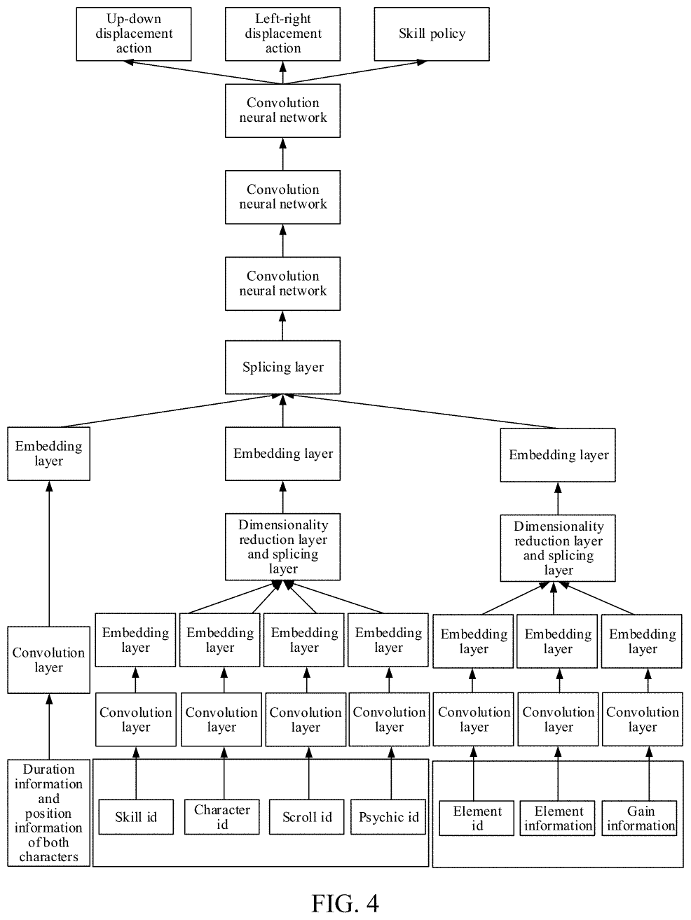

Schematically, the structure of the decision model may be shown in FIG. 4. By inputting information such as battle remaining duration information, position information of both characters, and skills, scrolls, psychics, and elements of both characters into the decision model, corresponding up-down displacement actions, left-right displacement actions, and skill policies may be obtained. The duration information and the position information of both characters may be inputted into a convolution layer for convolution processing, and then a convolution processing result is inputted into an embedding layer for embedding processing to obtain a first embedding processing result. And basic information corresponding to the virtual character, including skill id, character id, scroll id, and psychic id, may be respectively inputted into the convolution layer for convolution processing, and then inputted into the embedding layer for embedding processing. Thereafter, the embedding processing result corresponding to each piece of basic information may be inputted into a dimensionality reduction layer and a splicing layer for dimensionality reduction and splicing processing to obtain a second embedding processing result. The element information and gain information may be respectively inputted into the convolution layer for convolution processing, and then inputted into the embedding layer for embedding processing. Thereafter, the corresponding embedding processing results may be inputted into the dimensionality reduction layer and the splicing layer for dimensionality reduction and splicing processing to obtain a third embedding processing result. Thereafter, the first embedding processing result, the second embedding processing result, and the third embedding processing result are inputted into the splicing layer for splicing processing, and then a splicing result is inputted into a multi-layer convolution neural network to obtain an outputted battle policy, including up-down displacement actions, left-right displacement actions, and skill policies.

Operation 302: Update and train n^{th} decision models of the virtual characters based on battle data of a battle between the virtual characters in an n^{th} iteration process to obtain n+1^{th} decision models of the virtual characters, and add the n+1^{th} decision models to the model pools of the corresponding virtual characters.

In some embodiments of the disclosure, decision models of different virtual characters are updated and trained through multiple rounds of iteration process. In each round of iteration process, the decision model obtained from the previous round of training of the virtual character may be trained to obtain a latest decision model, and in one round of iteration process, the latest decision model of each virtual character may be obtained, thereby entering a next round of training process.

In some embodiments, when the computer device trains a decision model of a virtual character in a training process, the model may be trained using battle data between the virtual character and another virtual character, and the battle data is real-time battle data. When updating and training an n^{th} decision model of the virtual character, the computer device may control the virtual character to battle against another virtual character based on the n^{th} decision model, thereby updating and training the n^{th} decision model according to the obtained battle data, and obtaining an n+1^{th} decision model of the virtual character. And in the process of updating and training the n^{th} decision model, multiple battle data may be used for training. Different battle data includes battle data of the virtual character and another different virtual character.

Compared with the mode of training a general decision model using battle data among different virtual characters in the related art, in some embodiments, a specific decision model may be trained for each virtual character in a training process, and battle data of a to-be-trained virtual character and another virtual character is used for training, whereby the to-be-trained virtual character may rationally use own mechanism to battle, and the policy individuation improvement is realized.

Operation 303: Determine, in a case that an iterative training end condition is satisfied, decision models obtained by the last round of training in the model pools as application decision models of the virtual characters.

The iterative training end condition refers to a condition of ending the update and training of the corresponding decision models of the virtual characters. In each round of iterative training process, each virtual character has the latest training decision model added to the corresponding model pool. When the iterative training end condition is satisfied, it indicates that the specific decision model corresponding to each virtual character has been trained, the iterative training may be ended, and the decision model obtained by the last round of training in the model pool corresponding to each virtual character is determined as the application decision model of the virtual character.

When the virtual character is controlled to battle based on the application decision model, the winning rate is higher than other decision models in the corresponding model pool of the virtual character. After obtaining the application decision model of the virtual character, the virtual character may be controlled to battle based on the application decision model in application.

To sum up, in some embodiments of the disclosure, decision models corresponding to different virtual characters are iteratively trained for multiple rounds by utilizing battle data of the virtual characters in a battle process, so as to obtain application decision models corresponding to the virtual characters finally. Compared with the manner of training general decision models in the related art, in some embodiments of the disclosure, corresponding specific decision models are trained for virtual characters, whereby the virtual characters may rationally use own specific mechanisms to battle, thereby realizing the personalized improvement of battle policies for different virtual characters, and contributing to improving the battle winning rates of the virtual characters in the battle based on the decision models.

In some embodiments of the disclosure, during iterative training, after the latest decision model of the virtual character is trained, the latest decision model is added into the model pool of the virtual character, thereby training other virtual characters, whereby the other virtual characters may further improve the battle policy and realize the personalized battle of the virtual characters. Exemplary embodiments will be described below.

Operation 501: Obtain model pools of virtual characters.

In some embodiments, the model pools corresponding to the virtual characters include the same general decision model, which is applicable to the virtual characters. The general decision model is used for instructing the virtual characters to perform a basic battle operation. And the general decision model is a decision model obtained by iterative training of multiple battle data between different virtual characters.

In some embodiments, in a k^{th} round of iterative training process of the general decision model, a k^{th} decision model is used for determining a corresponding battle policy according to i^{th} battle state data, and the virtual character is controlled to act based on the battle policy, thereby obtaining i+1^{th} battle state data. The k^{th} decision model is trained using the variation of the battle state data to obtain a k+1^{th} decision model, and a k+1^{th} round of iterative training process is entered to continue the training of the k+1^{th} decision model. Different battle state data are battle state data of two battle virtual characters at different moments, and the battle state data may include state-action pairs and the number of wins/losses of the virtual characters. And after obtaining the k+1^{th} decision model, the k+1^{th} decision model may be added to an opponent model pool, and may be sampled as an opponent model for battles. When the opponent model is used for battles, the computer device uses the opponent model to control the opponent virtual character for battling. For example, in the k^{th} round of iterative training process, the computer device may control the virtual character through the k^{th} decision model, and control the opponent virtual character through the sampled opponent model, so as to battle between the virtual characters, obtain battle state data, and train the k^{th} decision model using the battle state data. Through the reuse of the decision model, the training efficiency of the general decision model may be improved.

After several rounds of iterative training, when the virtual character is controlled to battle based on the decision model, the battle winning rate of the virtual character will tend to be stable, that is, when the variation of the decision model obtained by the current round of training is smaller than a threshold compared with the decision model obtained by the previous round of training, the iterative training process may be ended, and the decision model obtained by the last round of training may be determined as a target general decision model.

During the training of the general decision model, different virtual characters may be controlled to battle based on the decision model, and multiple sets of battle data may be obtained, whereby the decision model is trained, and the final target general decision model is applied to the virtual characters.

In some embodiments, the general decision model contained in the model pool may contain multiple general decision models, and the multiple general decision models are general decision models obtained by the rounds of training in the iterative training process of the general decision models.

Operation 502: Update and train, based on battle data of a battle process between an i^{th} virtual character and another virtual character, an n^{th} decision model of the i^{th} virtual character to obtain an n+1^{th} decision model of the i^{th} virtual character in an n^{th} round of iteration process.

In some embodiments, when updating and training the decision models of the virtual characters, the computer device trains the decision models starting from the general decision model. That is, first decision models of the virtual characters are updated and trained in a first iteration process to obtain second decision models of the virtual characters. The first decision models of the virtual characters are the general decision models.

And in an n^{th} round of iteration process, when training an i^{th} virtual character, the i^{th} virtual character is controlled to battle against another virtual character, thereby updating and training an n^{th} decision model of the i^{th} virtual character to obtain an n+1^{th} decision model of the i^{th} virtual character based on multiple battle data. In this process, the computer device may sample for multiple times in the model pools corresponding to other virtual characters to obtain multiple decision models. After the decision model is obtained by sampling each time, the corresponding virtual character is controlled to battle against the i^{th} virtual character based on the sampled decision model, the corresponding battle data is obtained, and the n^{th} decision model is trained using the battle data.

Operation 503: Add the n+1^{th} decision model of the i^{th} virtual character to a model pool of the i^{th} virtual character.

In some embodiments, in the n^{th} round of iteration process, the n^{th} decision model of each virtual character is updated and trained in a sequential manner. That is, after training the n+1^{th} decision model of the i^{th} virtual character, the n^{th} decision model of the i+1^{th} virtual character is updated and trained.

After updating and training the n^{th} decision model of the i^{th} virtual character to obtain the n+1^{th} decision model, the computer device adds the n+1^{th} decision model to the model pool corresponding to the i^{th} virtual character. When updating and training the n^{th} decision model of the i+1^{th} virtual character, the newly trained decision model of the i^{th} virtual character may be sampled as an opponent model. Thus, when training the n^{th} decision model of the i+1^{th} virtual character, the n+1^{th} decision model of the i^{th} virtual character with a higher winning rate may be trained as an opponent model, thereby improving the policy of the n^{th} decision model.

Operation 504: Update and train, based on battle data of a battle process between an i+1^{th} virtual character and another virtual character, an n^{th} decision model of the i+1^{th} virtual character to obtain an n+1^{th} decision model of the i+1^{th} virtual character.

After the n+1^{th} decision model of the i^{th} virtual character is added to the model pool of the i^{th} virtual character, the n^{th} decision model of the i+1^{th} virtual character may be updated and trained. In the process of updating and training the decision model of the i+1^{th} virtual character, the battle data of the battle between the i+1^{th} virtual character and other virtual characters is updated and trained. In some embodiments, the n^{th} decision model of each virtual character is updated and trained in the same manner.

After obtaining the n+1^{th} decision model of the i+1^{th} virtual character, the model is also added to the model pool of the i+1^{th} virtual character, so as to update and train the n^{th} decision model of the next virtual character.

Operation 505: Enter an n+1^{th} iteration process in a case that the n+1^{th} decision models of the virtual characters are added to the model pools of the corresponding virtual characters.

After the n^{th} decision models of the virtual characters are updated and trained and the n+1^{th} decision models are added to the corresponding model pools, the n^{th} round of iteration process ends and the n+1^{th} round of iteration process is entered, and then the n+1^{th} decision models of the virtual characters are updated and trained in sequence.

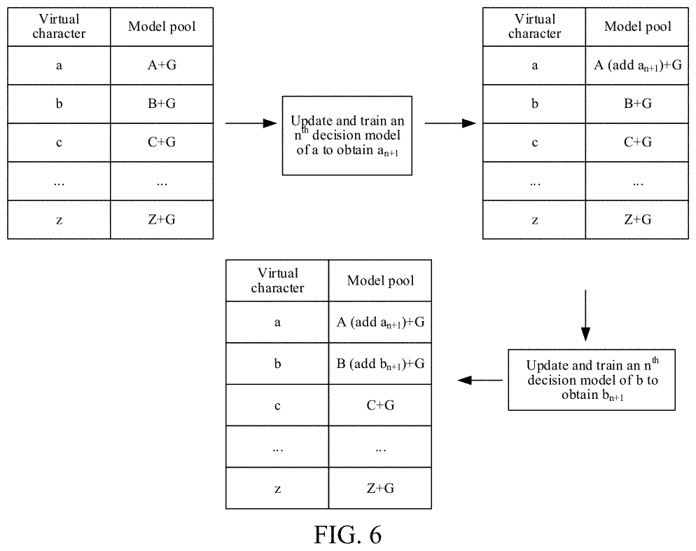

Schematically, as shown in FIG. 6, in an n^{th} round of iteration process, an n^{th} decision model of virtual character a is updated and trained, and a trained n+1^{th} decision model an+1 is added to a specific decision model pool A of virtual character a. A model pool G has a general decision model. Thereafter, an n^{th} decision model of b is updated and trained, a trained n+1^{th} decision model bn+1 is added to a specific decision model pool B of virtual character b, an n^{th} decision model of virtual character c is updated and trained until an n+1^{th} decision model zn+1 of virtual character z is added to a specific decision model pool Z, and an n+1^{th} round of iteration process is entered.

Operation 506: Determine that the iterative training end condition is satisfied in a case that battle winning rate variations of the virtual characters are smaller than a second threshold, and determine decision models obtained by the last round of training in the model pools as the application decision models of the virtual characters.

In some embodiments, it is determined whether the iterative training end condition is satisfied according to the variation of the battle winning rate of each virtual character. After several rounds of iterative training, the winning rate corresponding to the latest decision model obtained by virtual character training will tend to be stable. That is, when a battle winning rate variation is smaller than a second threshold, it is determined that the iterative training end condition is satisfied.

The battle winning rate variation may be a difference between the winning rates corresponding to the latest decision model and the decision model obtained in the previous round.

When the battle winning rate variation of each virtual character is smaller than the second threshold, it may be determined that the iterative training end condition is satisfied, and the iterative training process may be stopped. Schematically, the second threshold may be 1%.

In some embodiments, the decision model of each virtual character is sequentially updated in a round of iteration process. Thus, the updated decision model of the virtual character may be used as an opponent model in the subsequent training process of the decision model of the virtual character, whereby each virtual character learns a personalized policy and the battle winning rate is improved.

In some embodiments, when updating and training the decision model of the virtual character, sampling may be carried out according to the character strengths and weaknesses of other virtual characters except a to-be-trained virtual character and the model strengths and weaknesses in the model pool corresponding to other virtual characters, and a suitable opponent model may be selected, whereby corresponding battle data may be obtained based on battles between the opponent model and the decision model of the to-be-trained virtual character to realize the updating and training of the decision model of the to-be-trained virtual character. Exemplary embodiments will be described below.

Operation 701: Obtain model pools of virtual characters.

An implementation of this operation is similar to that of operation 301, and is not detailed in this embodiment.

Operation 702: Perform m^{th} model sampling from a model pool of a battle virtual character to obtain an m^{th} battle decision model in an n^{th} round of iteration process, the battle virtual character being a virtual character other than the i^{th} virtual character among the virtual characters.

In the n^{th} round of iteration process, when updating and training the n^{th} decision model of the i^{th} virtual character, updating training is required based on battle data between the i^{th} virtual character and other virtual characters. The other virtual characters are also controlled by the decision models corresponding to the characters. Therefore, the computer device first needs to sample the models in the corresponding model pools of other virtual characters, so as to obtain a battle decision model.

In the process of updating and training the n^{th} decision model, it is necessary to optimize the parameters of the n^{th} decision model for many times. In some embodiments, different battle data are used in each parameter optimization process, whereby the decision model may be optimized according to different battle data. The computer device may re-sample the model in the model pool during each optimization, and select a decision model with higher strength to battle, thereby continuously improving the model strength of the n^{th} decision model of the i^{th} virtual character.

In the process of performing m^{th} parameter optimization on the n^{th} decision model of the i^{th} virtual character, the computer device performs m^{th} model sampling in a model pool corresponding to the m^{th} battle virtual character to obtain the m^{th} battle decision model. Schematically, when the virtual character includes virtual character a, virtual character b, virtual character c, and virtual character d, if the i^{th} virtual character is virtual character a, the battle virtual character is virtual character b, virtual character c, and virtual character d, whereby model sampling is performed in a model pool corresponding to virtual character b, virtual character c, and virtual character d to obtain the m^{th} battle decision model. In the process of updating and training the n^{th} decision model, the total number of models in the model pool corresponding to the battle virtual character remains unchanged. That is, in the process of updating and training the decision model of the i^{th} virtual character, the decision models in the model pool of other virtual characters are not updated.

In some embodiments, model sampling may include the following operations:

Operation 702a: Perform m^{th} character sampling from the battle virtual character to obtain the m^{th} battle virtual character.

Since different battle virtual characters correspond to different decision models, when sampling the m^{th} battle decision model, the m^{th} battle virtual character may be obtained by sampling in the battle virtual character, and then model sampling may be performed from the model pool corresponding to the m^{th} battle virtual character to obtain the m^{th} battle decision model. The m^{th} battle virtual character is an opponent character of the i^{th} virtual character in an m^{th} battle process.

In some embodiments, during the m^{th} character sampling, the computer device samples from the battle virtual character to obtain the m^{th} battle virtual character based on an m^{th} character weight of the battle virtual character. The character sampling adopts a counterfactual regret minimization (CFR) sampling manner.

Different virtual characters in the battle virtual characters have different character weights. The character weight is a probability that the character is sampled during character sampling. That is, as the character weight is larger, the probability that the corresponding virtual character is selected as an opponent character is higher. When using CFR sampling, the character weight of the virtual character is updated based on a battle losing rate of the i^{th} virtual character. The character weight is positively correlated with the battle losing rate of the i^{th} virtual character. That is, when the i^{th} virtual character battles against the sampled battle virtual character, a higher losing rate of the i^{th} virtual character indicates higher character strength of the battle virtual character and a higher character weight corresponding to the sampled battle virtual character. In this way, the i^{th} virtual character may gradually battle against stronger opponents, whereby the i^{th} virtual character may rationally use own mechanism to battle in the process of gradually optimizing the n^{th} decision model corresponding to the i^{th} virtual character.

In order to make the first virtual character battle with different types of virtual characters, character sampling is performed again in each optimization process, whereby the computer device may update the decision model using battle data between the first virtual character and different types of virtual characters, and the decision model may be applied to the battle process between the first virtual character and different types of virtual characters. The character weights corresponding to the battle virtual characters are gradually updated with the battle of the i^{th} virtual characters. Therefore, the character weights of the battle virtual characters are different every time the character sampling is performed. During the m^{th} character sampling, sampling is required based on an m^{th} character weight of the battle virtual character.

Operation 702b: Perform m^{th} model sampling from a model pool corresponding to the m^{th} battle virtual character to obtain the m^{th} battle decision model.

After sampling the m^{th} battle virtual character, the m^{th} model sampling is performed from the corresponding model pool of the m^{th} battle virtual character to obtain the m^{th} battle decision model, namely an opponent model in the m^{th} battle process.

In some embodiments, the m^{th} battle decision model is sampled from the model pool corresponding to the m^{th} battle virtual character based on m^{th} model weights of decision models of the m^{th} battle virtual character in the process of the m^{th} model sampling.

The model sampling and the character sampling adopt the same manner: CFR sampling. And the model weights of the decision models are positively correlated with the battle losing rate of the i^{th} virtual character. Therefore, when sampling based on the model weights, the computer device may obtain a strong battle decision model by sampling, and optimize the battle policy of the n^{th} decision model of the i^{th} virtual character.

And when model sampling is performed in the model pool corresponding to the m^{th} battle virtual character, the model pool contains multiple general decision models and new decision models trained by the m^{th} battle virtual character in multiple rounds of iteration processes. The multiple general decision models are decision models obtained from each of the multiple rounds of iteration processes of training the general decision models. In the process of model training, there may be an opportunistic policy to make the virtual character win, but not a policy to make rational use of own mechanism. For example, when a close combat virtual character and a long-range attack virtual character battle against each other, in order to make the close combat virtual character win, there may be a policy to make the close combat virtual character move repeatedly to avoid the attack of the long-range attack virtual character. After a corresponding decision model is trained and added to a model pool, the decision model corresponding to the policy may be selected by another virtual character as an opponent model with probability, thus training the corresponding decision model of the another virtual character. If the another virtual character is a the long-range attack virtual character, the long-range attack virtual character also needs to move repeatedly to attack the opponent character for winning, whereby the battle policy of each virtual character gradually evolves into an irrational policy. Therefore, in some embodiments, when model sampling is performed, multiple general decision models and decision models obtained by each round of iteration are stored in the model pool, and CFR sampling is performed in the multiple decision models to avoid the evolution of the irrational policy.

Operation 703: Control, based on an n^{th} decision model optimized at an m−1^{th} time and the m^{th} battle decision model, the i^{th} virtual character to battle against an m^{th} battle virtual character to which the m^{th} battle decision model belongs to obtain an m^{th} battle result.

After the m^{th} battle decision model is obtained by sampling, an m^{th} battle may be started. In the process of the m^{th} battle, the computer device controls the i^{th} virtual character based on an n^{th} decision model optimized at an m−1^{th} time and controls an m^{th} battle virtual character based on the m^{th} battle decision model to battle, so as to obtain an m^{th} battle result. The battle result refers to a winning or losing result of the i^{th} virtual character.

In some embodiments, the process of the m^{th} battle may include the following operations:

Operation 1: Create at least two battles.

When the same decision model controls virtual characters to battle, indicated battle policies may be different, which may lead to different battle data and battle results. In the process of the m^{th} battle, if the n^{th} decision model of the i^{th} virtual character is trained only based on the data of the i^{th} virtual character and the m^{th} battle virtual character in the first battle, the probability of error is high. Therefore, in each battle process, the computer device creates at least two battles, so as to optimize the n^{th} decision model of the i^{th} virtual character using multiple battle data and battle results, thereby ensuring the optimization accuracy.

Operation 2: Control, based on the n^{th} decision model optimized at the m−1^{th} time and the m^{th} battle decision model, the i^{th} virtual character to battle against the m^{th} battle virtual character in the at least two battles to obtain at least two m^{th} battle results.

In some embodiments, in each battle, the computer device controls the i^{th} virtual character based on the same optimized n^{th} decision model and the m^{th} battle virtual character based on the same m^{th} battle decision model.

Schematically, when the second battle decision model obtained by the second model sampling is a b2 decision model in the model pool corresponding to virtual character b and the i^{th} virtual character is virtual character a, in each battle, virtual character a is controlled based on the n^{th} decision model optimized by the first time and virtual character b is controlled based on the second battle decision model to battle, so as to obtain multiple sets of battle data.

Operation 704: Perform parameter optimization on the n^{th} decision model optimized at the m−1^{th} time based on the m^{th} battle result to obtain an n^{th} decision model of the i^{th} virtual character optimized at an m^{th} time.

After the m^{th} battle result is obtained, parameter optimization may be performed on the n^{th} decision model optimized at the m−1^{th} time based on the m^{th} battle result. That is, parameter optimization may be performed on the n^{th} decision model optimized previously.

In some embodiments, parameter optimization is performed on the n^{th} decision model optimized at the m−1^{th} time based on the at least two m^{th} battle results to obtain the n^{th} decision model of the i^{th} virtual character optimized at the m^{th} time.

In the process of parameter optimization, the computer device may obtain at least two m^{th} battle results, and determine reward values of a state-action pair and a battle result in the battle process using a reward function, so as to perform parameter optimization on the n^{th} decision model based on the reward values. The reward value in the reward function is positively correlated with the battle winning rate of the i^{th} virtual character. Thus, in the process of parameter optimization, the optimized decision model provides a policy with a higher winning rate to obtain a specific decision model of the i^{th} virtual character.

And in the process of parameter optimization, the computer device determines the reward value based on state-action pairs during at least two battles and at least two m^{th} battle results. A first reward value may be determined based on the state-action pair and a second reward value may be determined based on the battle result. The first reward value may be determined according to a rationality parameter corresponding to the state-action pair, and the rationality parameter is used for indicating the rationality of an action adopted in a state indicated by the state-action pair. The rationality parameters may be determined according to preset rules, and different rational use states are set for different actions. For example, attack actions may be executed after controlling opponents. According to the rational use state corresponding to the action, a rationality parameter of a current state-action pair may be determined, and the rationality parameter is positively correlated with the first reward value. And the second reward value may also be determined according to the battle winning rate of the i^{th} virtual character indicated by the battle result. The second reward value is positively correlated with the battle winning rate. In order to improve the strength of the decision model, different weights may be set for different reward values. A second weight corresponding to the second reward value is higher than a first weight corresponding to the first reward value, so as to train the decision model corresponding to the i^{th} virtual character with winning as the guide.

In some embodiments, the computer device may use an algorithm of proximal policy optimization (PPO)+generalized advantage estimation (GAE) for parameter optimization when using the reward value for parameter optimization.

Operation 705: Update a first losing rate of the m^{th} battle virtual character and a second losing rate of the m^{th} battle decision model based on the m^{th} battle result.

The first losing rate refers to a losing rate of the i^{th} virtual character in a case that the i^{th} virtual character battles against a battle virtual character, and the second losing rate refers to a losing rate of the i^{th} virtual character in a case that a battle decision model controls the battle virtual character to battle against the i^{th} virtual character.

After obtaining the m^{th} battle result, the computer device needs to update the losing rate of the m^{th} battle virtual character, so as to update the character weights of the virtual characters and the model weights of the decision models based on the updated losing rate to obtain an m+1^{th} character weight and an m+1^{th} model weight. In an m+1^{th} optimization process, an m+1^{th} battle decision model is obtained by re-sampling based on the m+1^{th} character weight and the m+1^{th} model weight.

In some embodiments, the computer device updates a first losing rate of the m^{th} battle virtual character and a second losing rate of the m^{th} battle decision model based on the m^{th} battle result. The first losing rate of the m^{th} battle virtual character refers to a losing rate in a case that the i^{th} virtual character battles against the m^{th} battle virtual character. The second losing rate of the m^{th} battle decision model refers to a losing rate of the i^{th} virtual character in a case that the m^{th} battle decision model battles as an opponent model.

The first losing rate is updated in the same manner as the second losing rate. The following is an example to update the second losing rate. The modes are as follows:

lᵢ′=γ*+(1−γ)*(1−f) (1)

where f represents the battle result (f=0 represents losing of the i^{th} virtual character, and f=1 represents winning of the i^{th} virtual character), and f may be determined according to a mean of at least two m^{th} battle results. For example, when the results indicating winning of the i^{th} virtual character in the at least two m^{th} battle results is more than the results indicating losing of the i^{th} virtual character, it is determined that the i^{th} virtual character wins.

γ is a discount factor, representing an inheritance ratio from the previous value, which may be adjusted according to sampling requirements. γ may be 0.9. lᵢ represents the second losing rate of the m^{th} battle decision model in the previous round.

The first losing rates corresponding to the virtual characters are initially equal to the second losing rates corresponding to the decision models, being 0.5.

Operation 706: Update the m^{th} character weight based on the first losing rate to obtain an m+1^{th} character weight.

After obtaining the first losing rate, the computer device may update the m^{th} character weight of each virtual character in the battle virtual characters based on the first losing rate to obtain an m+1th character weight.

Operation 707: Update the m^{th} model weight based on the second losing rate to obtain an m+1^{th} model weight.

Similarly, the computer device may update the m^{th} model weight of each decision model based on the second losing rate to obtain an m+1^{th} model weight. The manner of updating the m^{th} character weight based on the first losing rate and the manner of updating the m^{th} model weight based on the second losing rate are the same, and the manner of updating the m^{th} model weight based on the second losing rate will be described below as an example. The mode may include the following operations:

Operation 707a: Determine a losing rate mean based on the second losing rate, the losing rate mean being a mean of second losing rates of the decision models in the model pool of the m^{th} battle character.

When the second losing rate corresponding to the m^{th} battle decision model is updated, a losing rate mean of each decision model in the model pool corresponding to the m^{th} battle virtual character will vary accordingly.

The losing rate mean is calculated in the following manners:

utility=E(l)=Σⱼ₌₁^{k}lⱼ*wⱼ (2)

where lⱼ is the second losing rate corresponding to a j^{th} decision model, the second losing rate of the m^{th} battle decision model is an updated second losing rate lᵢ′, and wⱼ is the model weight corresponding to the j^{th} decision model.

Operation 707b: Determine a losing rate variation of each decision model based on the losing rate mean, the losing rate variation being a difference between the second losing rate and the losing rate mean.

After the losing rate mean is obtained, a losing rate variation of each decision model may be determined based on the losing rate mean. The losing rate variation is determined in the following manners:

Δuⱼ=lⱼ−E(l) (j=1,2 . . . k) (3)

Similarly, when determining the losing rate variation of the m^{th} battle decision model, the losing rate variation is determined using the updated second losing rate lᵢ′.

Operation 707c: Update a regret value of the decision model based on the losing rate variation, the losing rate variation being positively correlated with the regret value.

In some embodiments, after determining the losing rate variation corresponding to each decision model, a regret value of each decision model may be updated based on the losing rate variation. The modes are as follows:

r′ⱼ=max(rⱼ+Δuⱼ,0) (4)

where rⱼ is the regret value of the model obtained from the last update. When the losing rate variation is larger, the updated regret value of the model is larger. And the initial regret value of each decision model is 0.

Operation 707d: Update the m^{th} model weight of the decision model based on the regret value of the decision model to obtain the m+1th model weight, the regret value being positively correlated with the model weight.

After obtaining the regret value of each model, the m^{th} model weight of each decision model is updated based on the regret value of the decision model. The initial weights of the decision models are the same, which are all 1/k, where k is the total number of models in the model pool corresponding to the m^{th} battle virtual character.

The m^{th} model weight is updated in the following manners:

$${w}_{j}^{′} = {β}^{*} \frac{1}{k} + ( 1 - β ) * \frac{{r}_{j}^{′}}{{\sum }_{l = 1}^{k} {r}_{l}^{′}} ( j = 1 , 2 , … , k ) \qquad ( 5 )$$

where β is a discount factor for balancing a proportional relationship between a mean weight 1/k and a weight obtained based on the regret value. β may be 0.5.

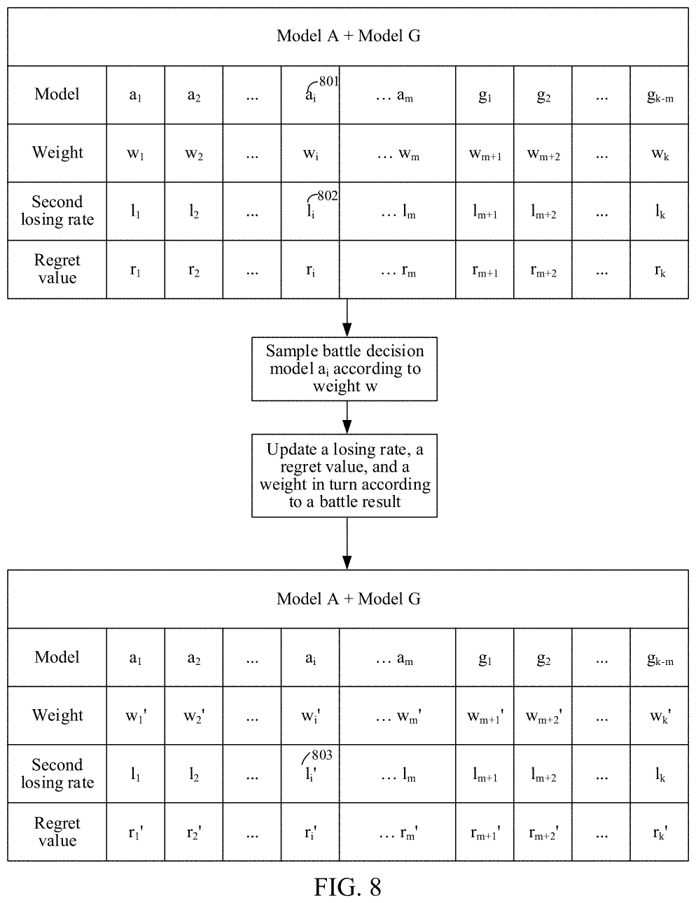

In some embodiments, the process of updating the model weight may be shown in FIG. 8. When a selected battle virtual character is character a and a decision model is a, 801 in an m^{th} parameter optimization process, a second losing rate lᵢ 802 corresponding to decision model a, 801 is updated based on the battle result to obtain lᵢ′ 803, regret values of decision models corresponding to virtual character a (including regret values of specific decision models a₁-aₘ and general decision models g₁-gₖ₋ₘ) are sequentially updated, and then model weights of the decision models are updated based on the regret values.

In some embodiments, only the implementations of operation 706 and operation 707 are illustrated but the execution timing is not limited. The two operations may be performed successively or synchronously.

Operation 708: Stop parameter optimization on the n^{th} decision model of the i^{th} virtual character in a case that a policy convergence condition is satisfied, and determine an n^{th} decision model optimized at the last time as the n+1^{th} decision model of the i^{th} virtual character.

In some embodiments, multiple parameter optimizations are performed on the n^{th} decision model of the i^{th} virtual character. In some embodiments, the parameter optimization process is stopped when the policy convergence condition is satisfied.

It may be determined that the policy convergence condition is satisfied in a case that a battle winning rate variation of the i^{th} virtual character is smaller than a first threshold, and parameter optimization on the n^{th} decision model of the i^{th} virtual character is stopped.

After multiple parameter optimizations are performed on the n^{th} decision model of the i^{th} virtual character, the battle winning rate of the i^{th} virtual character and other virtual characters will tend to be stable. When the battle winning rate tends to be stable, it is determined that the n^{th} decision model of the i^{th} virtual character has been updated and trained in the iteration process, whereby the n^{th} decision model after the last optimization is determined as the n+1^{th} decision model of the i^{th} virtual character. When the battle winning rate variation of the i^{th} virtual character is smaller than a first threshold, it is determined that the battle winning rate tends to be stable. Schematically, the first threshold may be 1%.

Operation 709: Add the n+1^{th} decision model of the i^{th} virtual character to a model pool of the i^{th} virtual character.

An embodiment of this operation is similar to the foregoing embodiment, and this embodiment is not detailed.

Operation 710: Update and train, based on battle data of a battle process between an i+1^{th} virtual character and another virtual character, an n^{th} decision model of the i+1^{th} virtual character to obtain an n+1^{th} decision model of the i+1^{th} virtual character.

In some embodiments, the process of updating and training the n^{th} decision model of the i+1^{th} virtual character is the same as the process of training the n^{th} decision model of the i^{th} virtual character.

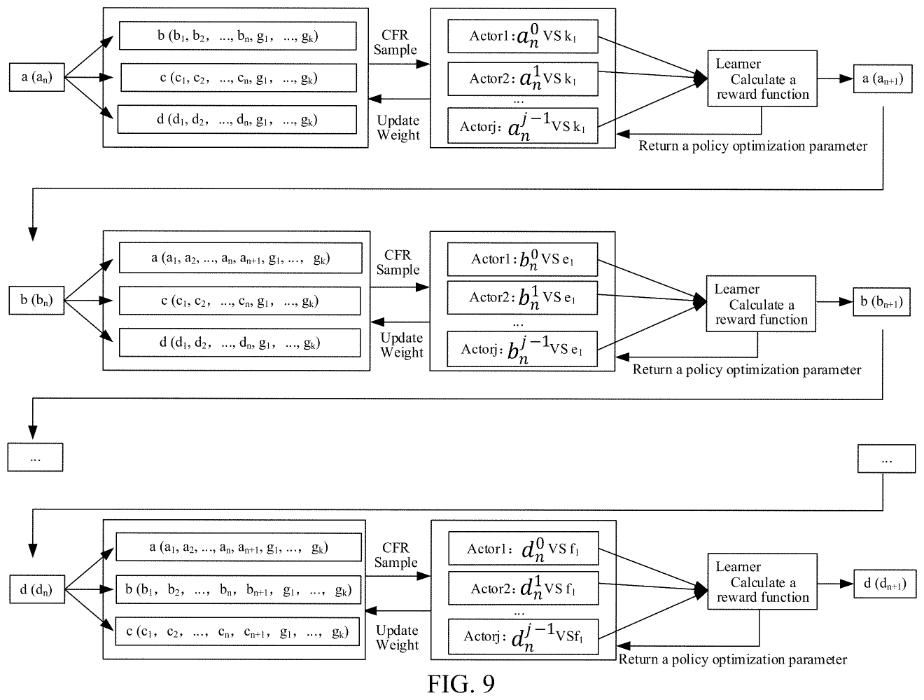

Schematically, as shown in FIG. 9, in the n^{th} iteration process, when the virtual characters include virtual character a, virtual character b, virtual character c, and virtual character d, the n^{th} decision model of virtual character a is first updated and trained. The model is updated and trained using multiple Actor structures+1learner structures. Taking the first optimization process as an example, in the first optimization process of an, the same decision model an is used in each Actor structure to battle against k₁, where k₁ is a decision model obtained from the first CFR sampling. After battling, a learner may calculate a reward function based on battle data and battle results of multiple an and k₁, so as to determine an optimization parameter, and then return a policy optimization parameter to an Actor, whereby the Actor obtains the first optimized an. Also, character weights corresponding to virtual character b, virtual character c, and virtual character d and model weights in the corresponding model pool are updated based on the battle results of multiple aₙ and k₁. After the weights are updated, the second CFR sampling is performed to obtain model k₂, and the first optimized an and model k₂ are controlled to battle by multiple Actor structures. The second optimization is performed using the battle data, and the character weights and the model weights are re-updated to iteratively perform multiple optimization processes. When the policy converges, model aₙ₊₁ is outputted, and model aₙ₊₁ is added into a corresponding model pool A, and an n^{th} decision model of virtual character b is continuously updated and trained to obtain an n+1^{th} decision model bₙ₊₁ of virtual character b. n^{th} decision models of the subsequent virtual characters are continuously trained, and the n^{th} iteration process is ended until an n+1^{th} decision model dₙ₊₁ of virtual character d is obtained by training.

Operation 711: Enter an n+1^{th} iteration process in a case that the n+1^{th} decision models of the virtual characters are added to the model pools of the corresponding virtual characters.

Operation 712: Determine, in a case that an iterative training end condition is satisfied, decision models obtained by the last round of training in the model pools as application decision models of the virtual characters.

The implementations of operation 711 and operation 712 are similar to the implementations of operation 505 and operation 506 in the foregoing embodiment, and will not be detailed in this embodiment.

In some embodiments, in the process of updating and training the decision model of the virtual character, stronger opponent characters and opponent decision models are continuously selected through CFR sampling, thereby optimizing the specific battle policy of the virtual character and improving the battle winning rate of the virtual character.

To sum up, in this embodiment of the disclosure, decision models corresponding to different virtual characters are iteratively trained for multiple rounds by utilizing battle data of the virtual characters in a battle process, so as to obtain target decision models corresponding to the virtual characters finally. Compared with the manner of training general decision models in the related art, in this embodiment of the disclosure, corresponding specific decision models are trained for virtual characters, whereby the virtual characters may rationally use own specific mechanisms to battle, thereby realizing the personalized improvement of battle policies for different virtual characters, and contributing to improving the battle winning rates of the virtual characters in the battle based on the decision models.

When the decision models corresponding to different virtual characters are trained in multiple iterations, the decision models corresponding to the virtual characters are trained in turn in one training process, whereby the decision model of the virtual character obtained by the latest training may be trained as an opponent model of the decision model of the virtual character that has not been trained in the current iteration process. Since the decision model of the virtual character obtained by the latest training has a better corresponding policy, the optimization effect of the decision model may be improved by training the decision model of the virtual character that has not been trained as the opponent model.

When the decision model of the same virtual character is updated and trained, the optimized decision model is obtained based on multiple sets of battle data between a to-be-trained virtual character and different virtual characters. That is, in the training process of the decision model of the same virtual character, one side is a model of a fixed virtual character, while the other side is models of different virtual characters. The overall income is the winning rate of the fixed virtual character. Therefore, in order to improve the winning rate of the fixed virtual character as much as possible, the learned decision will make the virtual character use own mechanism to battle as much as possible, so as to obtain a specific decision model corresponding to a personalized policy, and make the virtual character rationally use own mechanism, thereby improving the battle winning rate when battling based on own specific decision model.

In addition, in the process of training using the battle data between the virtual character and different virtual characters, character sampling and model sampling are performed using CFR sampling, whereby the virtual character battles against the stronger virtual character and the stronger decision model as much as possible in each optimization process. On the one hand, a more suitable opponent character and opponent model may be selected for battling in each optimization process to avoid the waste of computing resources. On the other hand, due to the continuous training with the stronger opponent character and the opponent model, the optimization effect of the corresponding decision model of the virtual character may be improved, thus improving the battle winning rate of the virtual character in automatic battle.

And since each optimization will perform CFR sampling, continuous training with battle data of an irrational opponent character or opponent model is avoided. Since continuous training with the irrational opponent character or opponent model will cause irrational policy evolution, for example, training based on battle data of an opponent character with an attribute restraint effect may cause policy learning deviation, and an adaptive opponent character and opponent model may be selected through multiple CFR sampling, thus ensuring the rationality of policy evolution.

When the decision model is optimized by using the battle data between the virtual characters, each time two virtual characters are controlled to automatically battle with corresponding decision models, multiple battles will be created simultaneously. Since the battle policy indicated by the same decision model in different battle processes may have deviation, multiple sets of battle data based on the same decision model may be obtained by multiple sets of battle data, thereby ensuring the accuracy of the battle data used for training.

When the iterative training is finally finished, the iterative training is finished in a case that the battle winning rate of each virtual character is stable, so as to ensure that the target decision model of each virtual character may be optimized to a great extent, and the winning rate of each virtual character in automatic battle may be improved.

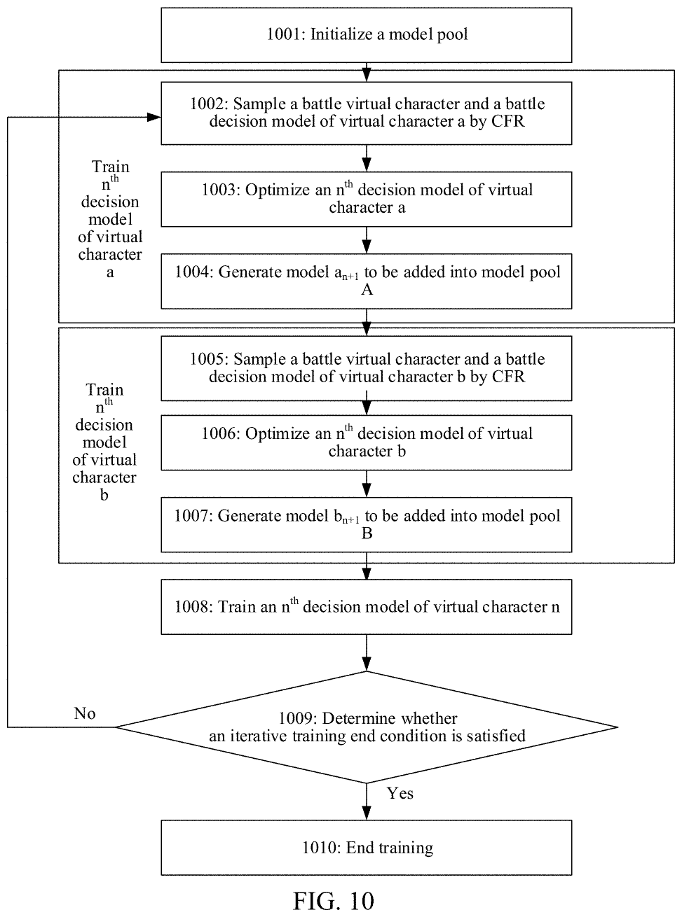

In some embodiments, the decision model training process is as shown in FIG. 10:

Operation 1001: Initialize a model pool.

The initial model pool of each virtual character contains the same general decision model.

Operation 1002: Sample a battle virtual character and a battle decision model of virtual character a by CFR.

In the process of training the decision model of character a, the battle virtual character is sampled by CFR sampling, and then the battle decision model is obtained by CFR sampling in the model pool of the battle virtual character.

Operation 1003: Optimize an n^{th} decision model of virtual character a.

The computer device controls virtual character a through the n^{th} decision model, and controls the battle virtual character to battle through the battle decision model, thereby optimizing the n^{th} decision model of the virtual character according to battle data.

After each battle, the character weights of other virtual characters and the model weights of the decision model are updated according to battle results, and then CFR sampling is performed again to obtain a battle virtual character and a battle decision model adopted in the next optimization process.

Operation 1004: Generate model aₙ₊₁ to be added into model pool A.

After optimizing the n^{th} decision model of virtual character a, an n+1^{th} decision model is obtained and added into the corresponding model pool A.

Operation 1005: Sample a battle virtual character and a battle decision model of virtual character b by CFR.

After obtaining the n+1^{th} decision model corresponding to virtual character a, an n^{th} decision model of virtual character b is trained continuously. The latest n+1^{th} decision model corresponding to virtual character a may be sampled in the CFR sampling process, which is helpful to improve the model strength of the decision model of virtual character b.

Operation 1006: Optimize an n^{th} decision model of virtual character b.

Operation 1007: Generate model bn+1 to be added into model pool B.

Operation 1008: Train an n^{th} decision model of virtual character n.

The computer device trains the n^{th} decision models of the virtual characters in turn.

Operation 1009: Determine whether an iterative training end condition is satisfied, if yes, perform operation 1010, otherwise, perform operation 1002.

Operation 1010: End training.

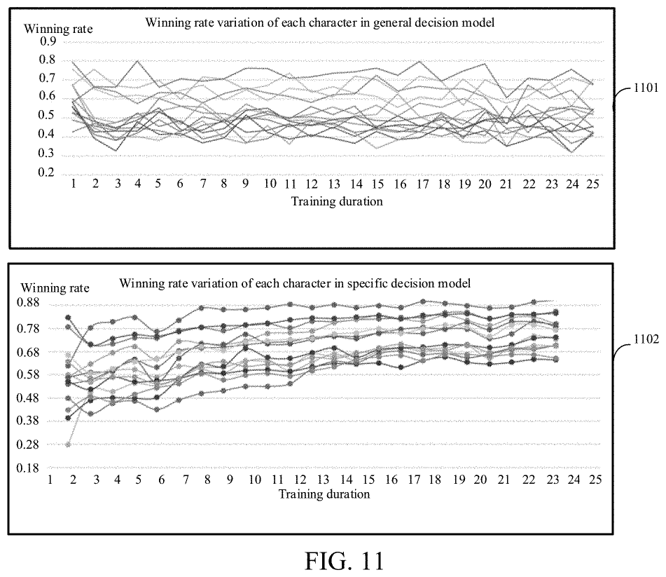

Schematically, as shown in FIG. 11, in the related art, when a general decision model is used, the winning rate variation of each virtual character in each round of iterative training process is shown by different lines in chart 1101. When the method provided in this embodiment is adopted, after multiple rounds of iteration, the winning rate variation of each virtual character is shown by different lines in chart 1102, which may be improved compared with the winning rate of each virtual character in the related art.

In the foregoing embodiment, the decision model training method is illustrated by being applied to a game. In another possible scene, the decision model training method provided by this embodiment of the disclosure may be applied to other industrial fields, such as an intelligent security robot.

When the method is applied to an intelligent security robot, the target decision models corresponding to different types of robots may be trained respectively for different types of robots, whereby various types of robots may attack or defend based on own characteristics when making decision actions indicated by the corresponding target decision models.

In some embodiments, when training decision models corresponding to different types of robots, multiple rounds of training may be performed for each decision model by utilizing multiple sets of battle data between different types of robots. For example, multiple sets of battle data between an attack robot and a defense robot, an attack robot and a balance robot, and a defense robot and a balance robot may be trained to obtain target decision models corresponding to the attack robot, the defense robot and the balance robot, whereby various types of robots may carry out security based on own attack characteristics or defense characteristics when acting, thereby improving the security effect of the intelligent security robot.

Further, for different robots belonging to the same type, the target decision models corresponding to different robots may be further trained. For example, for various robots belonging to attack robots, specific decision models may be trained respectively, whereby various robots may attack based on own attack characteristics when attacking based on the specific decision models, thus improving the attack effect of various robots.

The method is illustrated above by being only applied to the intelligent security robot, but is not limited thereto. The decision model training method provided by this embodiment of the disclosure may be applied to any object requiring automatic fighting.

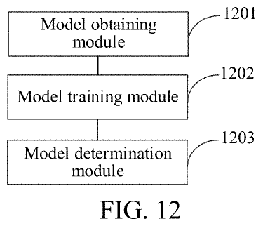

FIG. 12 shows a structural block diagram of a decision model training apparatus according to an exemplary embodiment of the disclosure. As shown in FIG. 12, the apparatus includes:

a model obtaining module 1201, configured to obtain model pools of virtual characters, the model pools including decision models of the virtual characters, and the decision models being used for indicating battle policies adopted by the virtual characters in battles;

a model training module 1202, configured to update and train n^{th} decision models of the virtual characters based on battle data of a battle between the virtual characters in an n^{th} iteration process to obtain n+1^{th} decision models of the virtual characters, and add the n+1^{th} decision models to the model pools of the corresponding virtual characters; and

a model determination module 1203, configured to determine, in a case that an iterative training end condition is satisfied, decision models obtained by the last round of training in the model pools as application decision models of the virtual characters.

The model training module 1202 may be further configured to:

update and train, based on battle data of a battle process between an i^{th} virtual character and another virtual character, an n^{th} decision model of the i^{th} virtual character to obtain an n+1^{th} decision model of the i^{th} virtual character;

add the n+1^{th} decision model of the i^{th} virtual character to a model pool corresponding to the i^{th} virtual character;

update and train, based on battle data of a battle process between an i+1^{th} virtual character and another virtual character, an n^{th} decision model of the i+1^{th} virtual character to obtain an n+1^{th} decision model of the i+1^{th} virtual character; and

enter an n+1^{th} iteration process in a case that the n+1^{th} decision models of the virtual characters are added to the model pools of the corresponding virtual characters.

The model training module 1202 may be further configured to:

perform m^{th} model sampling from a model pool of a battle virtual character to obtain an m^{th} battle decision model, the battle virtual character being a virtual character other than the i^{th} virtual character among the virtual characters;

control, based on an n^{th} decision model optimized at an m−1^{th} time and the m^{th} battle decision model, the i^{th} virtual character to battle against an m^{th} battle virtual character to which the m^{th} battle decision model belongs to obtain an m^{th} battle result;

perform parameter optimization on the n^{th} decision model optimized at the m−1^{th} time based on the m^{th} battle result to obtain an n^{th} decision model of the i^{th} virtual character optimized at an m^{th} time; and

stop parameter optimization on the n^{th} decision model of the i^{th} virtual character in a case that a policy convergence condition is satisfied, and determine an n^{th} decision model optimized at the last time as the n+1^{th} decision model of the i^{th} virtual character.

The model training module 1202 may be further configured to:

perform m^{th} character sampling from the battle virtual character to obtain the m^{th} battle virtual character; and

perform m^{th} model sampling from a model pool of the m^{th} battle virtual character to obtain the m^{th} battle decision model, character sampling and model sampling adopting a CFR sampling manner.

The model training module 1202 may be further configured to:

sample from the battle virtual character to obtain the m^{th} battle virtual character based on an m^{th} character weight of the battle virtual character.

The operation of performing m^{th} model sampling from a model pool corresponding to the m^{th} battle virtual character to obtain the m^{th} battle decision model includes:

sampling from the model pool corresponding to the m^{th} battle virtual character to obtain the m^{th} battle decision model based on m^{th} model weights of decision models of the m^{th} battle virtual character.

The character weights and the model weights are positively correlated with a battle losing rate of the i^{th} virtual character.

The apparatus may further include:

an update module, configured to update a first losing rate of the m^{th} battle virtual character and a second losing rate of the m^{th} battle decision model based on the m^{th} battle result, the first losing rate referring to a losing rate of the i^{th} virtual character in a case that the i^{th} virtual character battles against a battle virtual character, and the second losing rate referring to a losing rate of the i^{th} virtual character in a case that a battle decision model controls the battle virtual character to battle against the i^{th} virtual character.

The update module may be further configured to update the m^{th} character weight based on the first losing rate to obtain an m+1^{th} character weight.

The update module may be further configured to update the m^{th} model weight based on the second losing rate to obtain an m+1^{th} model weight.

The update module may be further configured to:

determine a losing rate mean based on the second losing rate, the losing rate mean being a mean of second losing rates of the decision models in the model pool of the m^{th} battle character;

determine a losing rate variation of each decision model based on the losing rate mean, the losing rate variation being a difference between the second losing rate and the losing rate mean;

update a regret value of the decision model based on the losing rate variation, the losing rate variation being positively correlated with the regret value; and

update the m^{th} model weight of the decision model based on the regret value of the decision model to obtain the m+1^{th} model weight, the regret value being positively correlated with the model weight.

The model training module 1202 may be further configured to:

create at least two battles;

control, based on the n^{th} decision model optimized at the m−1^{th} time and the m^{th} battle decision model, the i^{th} virtual character to battle against the m^{th} battle virtual character in the at least two battles to obtain at least two m^{th} battle results; and

perform parameter optimization on the n^{th} decision model optimized at the m−1^{th} time based on the at least two m^{th} battle results to obtain the n^{th} decision model of the i^{th} virtual character optimized at the m^{th} time.

The model training module 1202 may be further configured to:

determine that the policy convergence condition is satisfied in a case that battle winning rate variations of the i^{th} virtual character and the battle virtual character are smaller than a first threshold, and stop parameter optimization on the n^{th} decision model of the i^{th} virtual character.

The model training module 1202 may be further configured to:

determine that the iterative training end condition is satisfied in a case that battle winning rate variations of the virtual characters are smaller than a second threshold, and determining decision models obtained by the last round of training in the model pools as the target decision models of the virtual characters.

The model pools may include general decision models.

The model training module 1202 may be further configured to:

update and train first decision models of the virtual characters in a first iteration process to obtain second decision models of the virtual characters, the first decision models of the virtual characters being the general decision models.

To sum up, in some embodiments of the disclosure, decision models corresponding to different virtual characters are iteratively trained for multiple rounds by utilizing battle data of the virtual characters in a battle process, so as to obtain application decision models corresponding to the virtual characters finally. Compared with the manner of training general decision models in the related art, in some embodiments of the disclosure, corresponding specific decision models are trained for virtual characters, whereby the virtual characters may rationally use own specific mechanisms to battle, thereby realizing the personalized improvement of battle policies for different virtual characters, and contributing to improving the battle winning rates of the virtual characters in the battle based on the decision models.

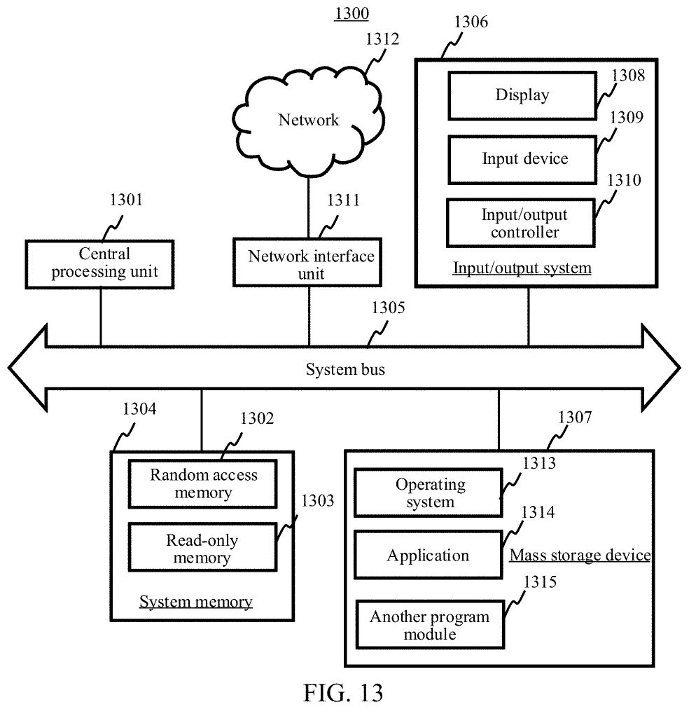

FIG. 13 is a schematic structural diagram of a computer device according to an exemplary embodiment of the disclosure. Specifically, the computer device 1300 includes a central processing unit (CPU) 1301, a system memory 1304 including a random access memory (RAM) 1302 and a read-only memory (ROM) 1303, and a system bus 1305 connecting the system memory 1304 and the CPU 1301. The computer device 1300 further includes a basic input/output (I/O) system 1306 that facilitates transfer of information between elements within a computer, and a mass storage device 1307 that stores an operating system 1313, an application 1314, and another program module 1315.

The basic I/O system 1306 includes a display 1308 for displaying information and an input device 1309 such as a mouse or a keyboard for inputting information by a user. The display 1308 and the input device 1309 are connected to the CPU 1301 through an I/O controller 1310 which is connected to the system bus 1305. The basic I/O system 1306 may further include the I/O controller 1310 for receiving and processing input from multiple other devices, such as a keyboard, a mouse, or an electronic stylus. Similarly, the I/O controller 1310 also provides output to a display screen, a printer, or another type of output device.

The mass storage device 1307 is connected to the CPU 1301 through a mass storage controller (not shown) connected to the system bus 1305. The mass storage device 1307 and a computer-readable medium associated therewith provide non-volatile storage for the computer device 1300. That is to say, the mass storage device 1307 may include a computer-readable storage medium (not shown) such as a hard disk or a drive.

In general, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, a flash memory or another solid-state memory technology, a compact disc read-only memory (CD-ROM), a digital versatile disc (DVD) or another optical memory, a tape cartridge, a magnetic tape, a magnetic disk memory, or another magnetic storage device. Certainly, a person skilled in the art may learn that the computer storage medium is not limited to the foregoing several types. The foregoing system memory 1304 and mass storage device 1307 may be collectively referred to as a memory.

The memory stores one or more programs. The one or more programs are configured to be executed by one or more CPUs 1301. The one or more programs include instructions for implementing the foregoing method. The CPU 1301 executes the one or more programs to implement the method provided in the foregoing various method embodiments.

According to the embodiments of the disclosure, the computer device 1300 may further be connected, through a network such as the Internet, to a remote computer on the network and run. That is, the computer device 1300 may be connected to a network 1312 through a network interface unit 1311 which is connected to the system bus 1305, or may be connected to another type of network or remote computer system (not shown) by using the network interface unit 1311.

The memory may further include one or more programs. The one or more programs are stored in the memory. The one or more programs include operations to be executed by the computer device in the method provided in this embodiment of the disclosure.

Some embodiments of the disclosure also provide a computer-readable storage medium. The readable storage medium stores at least one instruction, at least one program, a code set, or an instruction set. The at least one instruction, the at least one program, the code set, or the instruction set is loaded and executed by a processor to implement the decision model training method in any one of the foregoing embodiments.

Some embodiments of the disclosure provide a computer program product or computer program. The computer program product or computer program includes computer instructions. The computer instructions are stored in a computer-readable storage medium. A processor of a computer device reads the computer instructions from the computer-readable storage medium. The processor executes the computer instructions, whereby the computer device performs the decision model training method provided in the foregoing aspects.

A person of ordinary skill in the art may understand that all or some of the operations of the methods in the foregoing embodiment may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and that is not assembled in a terminal. The computer-readable storage medium stores at least one instruction, at least one program, a code set, or an instruction set. The at least one instruction, the at least one program, the code set, or the instruction set is loaded or executed by the processor to implement the decision model training method in any one of the foregoing embodiments.

The computer-readable storage medium may include: a ROM, a RAM, a solid state drive (SSD), or an optical disc. The RAM may include a resistance random access memory (ReRAM) and a dynamic random access memory (DRAM).

What is claimed is:

1. A decision model training method, performed by at least one processor and comprising:
obtaining model pools of virtual characters, the model pools comprising decision models of the virtual characters, and the decision models being used for indicating battle policies adopted by the virtual characters in battles;
updating and training n^{th} decision models of the virtual characters based on battle data of a battle between the virtual characters in an n^{th} iteration process to obtain n+1^{th} decision models of the virtual characters;
adding the n+1^{th} decision models to model pools of corresponding virtual characters; and
determining, based on an iterative training end condition being satisfied, decision models obtained by the last round of training in the model pools as application decision models of the virtual characters.

2. The method according to claim 1, wherein the updating and training n^{th} decision models of the virtual characters comprises:
updating and training an n^{th} decision model of the i^{th} virtual character based on battle data of a battle process between an i^{th} virtual character and a different virtual character to obtain an n+1^{th} decision model of the i^{th} virtual character;
adding the n+1^{th} decision model of the i^{th} virtual character to a model pool of the i^{th} virtual character;
updating and training an n^{th} decision model of the i+1^{th} virtual character based on battle data of a battle process between an i+1^{th} virtual character and the different virtual character to obtain an n+1^{th} decision model of the i+1^{th} virtual character; and
entering an n+1^{th} iteration process based on the n+1^{th} decision models of the virtual characters being added to the model pools of the corresponding virtual characters.

3. The method according to claim 2, wherein the updating and training an n^{th} decision model of the i^{th} virtual character comprises:
performing m^{th} model sampling from a model pool of a battle virtual character to obtain an m^{th} battle decision model, the battle virtual character being a virtual character other than the i^{th} virtual character among the virtual characters;
controlling the i^{th} virtual character based on an n^{th} decision model optimized at an m−1^{th} time and the m^{th} battle decision model to battle against an m^{th} battle virtual character to which the m^{th} battle decision model belongs to obtain an m^{th} battle result;
performing parameter optimization on the n^{th} decision model optimized at the m−1^{th} time based on the m^{th} battle result to obtain an n^{th} decision model of the i^{th} virtual character optimized at an m^{th} time;
stopping parameter optimization on the n^{th} decision model of the i^{th} virtual character based on a policy convergence condition being satisfied; and
determining an n^{th} decision model optimized at a last time as the n+1^{th} decision model of the i^{th} virtual character.

4. The method according to claim 3, wherein the performing m^{th} model sampling comprises:
performing m^{th} character sampling from the battle virtual character to obtain the m^{th} battle virtual character; and
performing m^{th} model sampling from a model pool of the m^{th} battle virtual character to obtain the m^{th} battle decision model, character sampling and model sampling adopting a counterfactual regret minimization (CFR) sampling manner.

5. The method according to claim 4, wherein the performing m^{th} character sampling comprises:
sampling from the battle virtual character to obtain the m^{th} battle virtual character based on an m^{th} character weight of the battle virtual character; and
sampling from the model pool of the m^{th} battle virtual character to obtain the m^{th} battle decision model based on m^{th} model weights of decision models of the m^{th} battle virtual character, the character weights and the model weights being positively correlated with a battle losing rate of the i^{th} virtual character.

6. The method according to claim 5, further comprising:
updating a first losing rate of the m^{th} battle virtual character and a second losing rate of the m^{th} battle decision model based on the m^{th} battle result, the first losing rate referring to a losing rate of the i^{th} virtual character based on the i^{th} virtual character battling against a battle virtual character, and the second losing rate referring to a losing rate of the i^{th} virtual character based on a battle decision model controlling the battle virtual character to battle against the i^{th} virtual character;
updating the m^{th} character weight based on the first losing rate to obtain an m+1^{th} character weight; and
updating the m^{th} model weight based on the second losing rate to obtain an m+1^{th} model weight.

7. The method according to claim 6, wherein the updating the m^{th} model weight comprises:
determining a losing rate mean based on the second losing rate, the losing rate mean being a mean of second losing rates of the decision models in the model pool of the m^{th} battle virtual character;
determining a losing rate variation of each decision model based on the losing rate mean, the losing rate variation being a difference between the second losing rate and the losing rate mean;
updating a regret value of the decision model based on the losing rate variation, the losing rate variation being positively correlated with the regret value; and
updating the m^{th} model weight of the decision model based on the regret value of the decision model to obtain the m+1^{th} model weight, the regret value being positively correlated with the model weight.

8. The method according to claim 3, wherein the controlling the i^{th} virtual character to battle against an m^{th} battle virtual character comprises:
creating at least two battles;
controlling the i^{th} virtual character, based on the n^{th} decision model optimized at the m−1^{th} time and the m^{th} battle decision model, to battle against the m^{th} battle virtual character in the at least two battles to obtain at least two m^{th} battle results; and
performing parameter optimization on the n^{th} decision model optimized at the m−1^{th} time based on the at least two m^{th} battle results to obtain the n^{th} decision model of the i^{th} virtual character optimized at the m^{th} time.

9. The method according to claim 3, wherein the stopping parameter optimization comprises:
determining that the policy convergence condition is satisfied based on a battle winning rate variation of the i^{th} virtual character being smaller than a first threshold; and
stopping parameter optimization on the n^{th} decision model of the i^{th} virtual character.

10. The method according to claim 1, wherein the determining the decision models comprises:
determining that the iterative training end condition is satisfied based on battle winning rate variations of the virtual characters being smaller than a second threshold; and
determining decision models obtained by the last round of training in the model pools as the application decision models of the virtual characters.

11. The method according to claim 1, wherein the model pools comprise general decision models; and
the updating and training n^{th} decision models comprises:
updating and training first decision models of the virtual characters in a first iteration process to obtain second decision models of the virtual characters, the first decision models of the virtual characters being the general decision models.

12. A decision model training apparatus comprising:
at least one memory configured to store program code; and
at least one processor configured to read the program code and operate as instructed by the program code, the program code comprising:
model obtaining code configured to cause the at least one processor to obtain model pools of virtual characters, the model pools comprising decision models of the virtual characters, and the decision models being used for indicating battle policies adopted by the virtual characters in battles;
model training code configured to cause the at least one processor to update and train n^{th} decision models of the virtual characters based on battle data of a battle between the virtual characters in an n^{th} iteration process to obtain n+1^{th} decision models of the virtual characters, and add the n+1^{th} decision models to model pools of corresponding virtual characters; and
model determination code configured to cause the at least one processor to determine, based on an iterative training end condition is satisfied, decision models obtained by the last round of training in the model pools as application decision models of the virtual characters.

13. The apparatus according to claim 12, wherein the model training code is further configured to cause the at least one processor to:
update and train an n^{th} decision model of the i^{th} virtual character based on battle data of a battle process between an i^{th} virtual character and a different virtual character to obtain an n+1^{th} decision model of the i^{th} virtual character;
add the n+1^{th} decision model of the i^{th} virtual character to a model pool of the i^{th} virtual character;
update and train an n^{th} decision model of the i+1^{th} virtual character based on battle data of a battle process between an i+1^{th} virtual character and the different virtual character to obtain an n+1^{th} decision model of the i+1^{th} virtual character; and
enter an n+1^{th} iteration process based on the n+1^{th} decision models of the virtual characters being added to the model pools of the corresponding virtual characters.

14. The apparatus according to claim 13, wherein the model training code is further configured to cause the at least one processor to:
perform m^{th} model sampling from a model pool of a battle virtual character to obtain an m^{th} battle decision model, the battle virtual character being a virtual character other than the i^{th} virtual character among the virtual characters;
control the i^{th} virtual character, based on an n^{th} decision model optimized at an m−1^{th} time and the m^{th} battle decision model, to battle against an m^{th} battle virtual character to which the mu′ battle decision model belongs to obtain an m^{th} battle result;
perform parameter optimization on the n^{th} decision model optimized at the m−1^{th} time based on the m^{th} battle result to obtain an n^{th} decision model of the i^{th} virtual character optimized at an m^{th} time; and
stop parameter optimization on the n^{th} decision model of the i^{th} virtual character based on a policy convergence condition is satisfied; and
determine an n^{th} decision model optimized at a last time as the n+1^{th} decision model of the i^{th} virtual character.

15. The apparatus according to claim 14, wherein the model training code is further configured to cause the at least one processor to:
perform m^{th} character sampling from the battle virtual character to obtain the m^{th} battle virtual character; and
perform m^{th} model sampling from a model pool of the m^{th} battle virtual character to obtain the m^{th} battle decision model, character sampling and model sampling adopting a counterfactual regret minimization (CFR) sampling manner.

16. The apparatus according to claim 15, wherein the model training code is further configured to cause the at least one processor to:
sample from the battle virtual character to obtain the m^{th} battle virtual character based on an m^{th} character weight of the battle virtual character; and
sample from the model pool of the m^{th} battle virtual character to obtain the m^{th} battle decision model based on m^{th} model weights of decision models of the m^{th} battle virtual character, the character weights and the model weights being positively correlated with a battle losing rate of the i^{th} virtual character.

17. The apparatus according to claim 16, wherein the program code further comprises updating code configured to cause the at least one processor to:
update a first losing rate of the m^{th} battle virtual character and a second losing rate of the m^{th} battle decision model based on the m^{th} battle result, the first losing rate referring to a losing rate of the i^{th} virtual character based on the i^{th} virtual character battles against a battle virtual character, and the second losing rate referring to a losing rate of the i^{th} virtual character based on a battle decision model controlling the battle virtual character to battle against the i^{th} virtual character;
update the m^{th} character weight based on the first losing rate to obtain an m+1^{th} character weight; and
update the m^{th} model weight based on the second losing rate to obtain an m+1^{th} model weight.

18. The apparatus according to claim 17, wherein the updating code is further configured to cause the at least one processor to:
determine a losing rate mean based on the second losing rate, the losing rate mean being a mean of second losing rates of the decision models in the model pool of the m^{th} battle virtual character;
determine a losing rate variation of each decision model based on the losing rate mean, the losing rate variation being a difference between the second losing rate and the losing rate mean;
update a regret value of the decision model based on the losing rate variation, the losing rate variation being positively correlated with the regret value; and
update the m^{th} model weight of the decision model based on the regret value of the decision model to obtain the m+1^{th} model weight, the regret value being positively correlated with the model weight.

19. The apparatus according to claim 14, wherein the model training code is further configured to cause the at least one processor to:
create at least two battles;
control the i^{th} virtual character, based on the n^{th} decision model optimized at the m−1^{th} time and the m^{th} battle decision model, to battle against the m^{th} battle virtual character in the at least two battles to obtain at least two m^{th} battle results; and
perform parameter optimization on the n^{th} decision model optimized at the m−1^{th} time based on the at least two m^{th} battle results to obtain the n^{th} decision model of the i^{th} virtual character optimized at the m^{th} time.

20. A non-transitory computer-readable storage medium, storing a computer program comprising instructions that when executed by at least one processor causes the at least one processor to:
obtain model pools of virtual characters, the model pools comprising decision models of the virtual characters, and the decision models being used for indicating battle policies adopted by the virtual characters in battles;
update and training n^{th} decision models of the virtual characters based on battle data of a battle between the virtual characters in an n^{th} iteration process to obtain n+1^{th} decision models of the virtual characters;
add the n+1^{th} decision models to model pools of corresponding virtual characters; and
determine, based on an iterative training end condition being satisfied, decision models obtained by the last round of training in the model pools as application decision models of the virtual characters.
